(19) United States
(12) Patent Application Publication
(10) Pub. No.: US 2022/0363262 A1
(43) Pub. Date: Nov. 17, 2022

(54) ROAD INFORMATION COLLECTION DEVICE

(71) Applicant: Alps Alpine Co., LTD, Tokyo (JP)

(72) Inventor: Shinji Watanabe, Iwaki (JP)

(73) Assignee: Alps Alpine Co., LTD, Tokyo (JP)

(21) Appl. No.: 17/742,241

(22) Filed: May 11, 2022

(30) Foreign Application Priority Data
May 13, 2021 (JP) 2021-081334

(51) Int. Cl. B60W 40/06; B60W 40/04; G06V 20/56; G06V 20/58

(52) U.S. Cl. CPC B60W 40/06; B60W 40/04; G06V 20/588; G06V 20/58; B60W 2554/4046; B60W 2554/4041; B60W 2420/42

(57) ABSTRACT

An in-vehicle device includes a vehicle detection unit that detects behavior of a user's own vehicle that is traveling, a neighboring vehicle detection unit that detects behavior of a neighboring vehicle preceding the user's vehicle, a neighboring vehicle following the user's vehicle, or both of neighboring vehicles, a road determination unit that determines the condition of a road on which the user's vehicle is traveling on the basis of behavior of the user's vehicle detected by the user's vehicle detection unit and behavior of a neighboring vehicle detected by the neighboring vehicle detection unit, and a transmission information creation unit and a transmission unit that transmit road information including a determination result by the road determination unit.

### RELATED APPLICATION

The present application claims priority to Japanese Patent Application Number 2021-081334, filed May 13, 2021, the entirety of which is hereby incorporated by reference.

### BACKGROUND

### 1. Field of the Invention

The present invention relates to a road information collection device that collects information related to a road on which a vehicle is traveling.

### 2. Description of the Related Art

Conventionally, there has been known an in-vehicle device that is mounted in a moving body such as a vehicle traveling on a road, determines behavior in a case of encountering an obstacle on the basis of output from a sensor that detects behavior of a vehicle, and in a case where the behavior is in a case of encountering an obstacle, such as avoiding an obstacle, transmits information including the behavior or cause of the behavior to an information distribution device (see, for example, JP 2008-234044 A).

In the in-vehicle device disclosed in JP 2008-234044 A described above, since the presence or absence of an obstacle is determined on the basis of behavior of a vehicle, there has been an issue that a case where the behavior of the vehicle is not caused by an obstacle, for example, a case where the behavior of the vehicle is based on erroneous steering wheel operation by the driver or the like cannot be distinguished, and the condition of a road including an obstacle cannot be accurately grasped.

The present disclosure has been devised in view of such circumstances, and an object of the present disclosure is to provide a road information collection device capable of accurately grasping the condition of a road.

### SUMMARY

In order to solve the above-described issue, a road information collection device according to the present disclosure includes a user's own vehicle detection unit that detects behavior of a user's vehicle that is traveling, a neighboring vehicle detection unit that detects behavior of a neighboring vehicle preceding the user's vehicle, a neighboring vehicle following the user's vehicle, or both of neighboring vehicles, a road determination unit that determines condition of a road on which the user's vehicle is traveling on the basis of behavior of the user's vehicle detected by the user's vehicle detection unit and behavior of a neighboring vehicle detected by the neighboring vehicle detection unit, and a road information transmission unit that transmits road information including a determination result by the road determination unit.

Not only the behavior of the user's own vehicle but also the behavior of neighboring vehicles that are preceding and following the user's vehicle are referred to, whereby whether the behavior of the user's vehicle is based on erroneous steering wheel operation or is based on a road state can be distinguished, and a factor not related to the road state such as erroneous steering wheel operation can be removed, and thus, the condition of a road can be accurately grasped.

In addition, the above-described road determination unit preferably determines the condition of a road including the presence or absence of an obstacle on a road. Specifically, the above-described road determination unit preferably determines that there is an obstacle in a case where the behavior of the user's vehicle is movement for avoiding an obstacle and the behavior of a neighboring vehicle is the same or similar movement of avoidance. As a result, it is possible to reliably recognize that there is an obstacle on a road that is large enough to be avoided during traveling.

In addition, the above-described road determination unit preferably determines the condition of a road including the presence or absence of damage to a road that obstructs traveling of a vehicle. Specifically, the above-described road determination unit preferably determines that there is a damaged spot on a road in a case where the behavior of the user's vehicle is movement of avoiding a damaged spot on a road and the behavior of a neighboring vehicle is movement that is the same as or similar to this movement. As a result, it is possible to reliably recognize that there is a dangerous spot on a road that needs to be avoided during traveling.

In addition, the road information collection device preferably further includes cameras that image the above-described neighboring vehicle, in which the neighboring vehicle detection unit preferably detects the behavior of a neighboring vehicle on the basis of an image obtained by imaging by the cameras. As a result, the behavior of a neighboring vehicle can be accurately detected.

In addition, the above-described neighboring vehicle detection unit preferably detects the behavior of a neighboring vehicle on the basis of movement of turned-on lights of a neighboring vehicle included in an image obtained by the cameras.

Since lights when turned on have high luminance, these portions can be easily extracted, and the behavior of a neighboring vehicle can be detected by simple processing.

### BRIEF DESCRIPTION OF THE DRAWINGS

FIG. 1 is a diagram illustrating a general configuration of a road information collection system according to one embodiment;

FIG. 2 is a diagram illustrating a configuration of an in-vehicle device;

FIG. 3 is a flowchart illustrating an operation procedure for detecting a dangerous spot such as an obstacle during traveling and transmitting the information; and

FIGS. 4A to 4B are diagrams illustrating an outline of dangerous spot detection.

### DETAILED DESCRIPTION OF THE PREFERRED EMBODIMENTS

Hereinafter one embodiment of a road information collection system according to the present invention will be described with reference to the drawings.

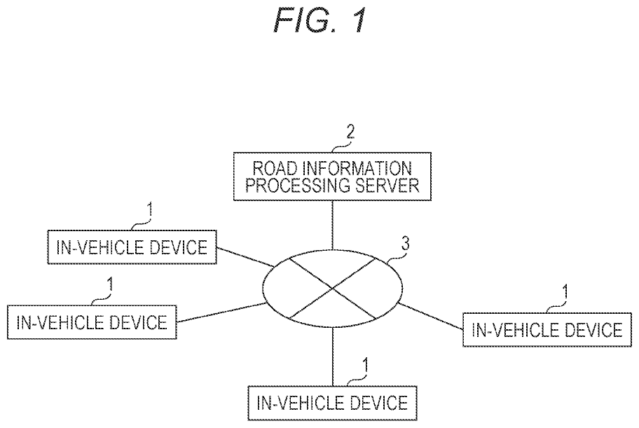

FIG. 1 is a diagram illustrating a general configuration of the road information collection system according to one embodiment. The road information collection system of the present embodiment includes in-vehicle devices 1 as road information collection devices mounted in a plurality of respective vehicles driven by users, and a road information processing server 2 connected to the in-vehicle devices 1 via a network 3.

In the present embodiment, a case where an obstacle is left on a road, a case where there is a damaged spot such as a cave-in in a part of a road, and the like are assumed. A vehicle traveling on this road (in actuality, an in-vehicle device 1 mounted in the vehicle) detects an obstacle or the like when passing by the place of the obstacle or the like, and transmits road information to the road information processing server 2. Upon receiving the road information, the road information processing server 2 creates notification information for notifying the presence of the obstacle or the like, and distributes the notification information to a vehicle traveling near the obstacle or the like. The vehicle (in-vehicle device 1) that has received the notification information performs a warning operation related to the obstacle or the like, such as notifying the driver of information related to the obstacle or the like indicated by the notification information.

Note that a vehicle (first vehicle) that first detects an obstacle or the like and transmits road information to the road information processing server 2 is different from a vehicle (second vehicle) that receives notification information sent from the road information processing server 2 before reaching a place of the obstacle or the like, but the in-vehicle devices 1 include two functions of performing various types of processing related to an obstacle in the first and second vehicles. The present embodiment mainly focuses on operation of the first vehicle that detects an obstacle or the like, creates road information, and transmits the road information to the road information processing server 2, and the description of operation of the second vehicle is omitted.

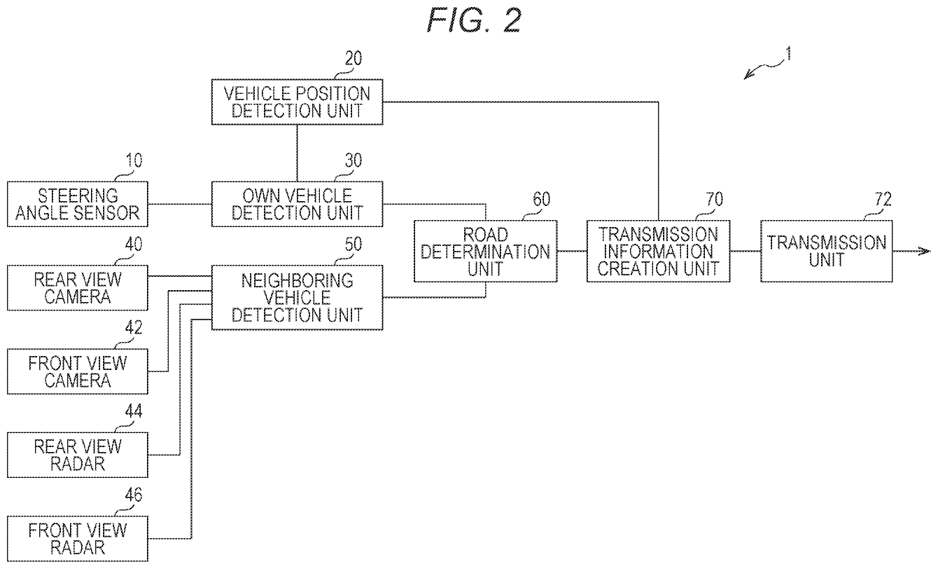

FIG. 2 is a diagram illustrating a configuration of an in-vehicle device 1. As illustrated in FIG. 2, the in-vehicle device 1 of the present embodiment includes a steering angle sensor 10, a vehicle position detection unit 20, a user's own vehicle detection unit 30, a rear view camera 40, a front view camera 42, a rear view radar 44, a front view radar 46, a neighboring vehicle detection unit 50, a road determination unit 60, a transmission information creation unit 70, and a transmission unit 72.

The steering angle sensor 10 detects a steering angle of a steering wheel (not illustrated) provided for a driver's seat of the user's vehicle.

The vehicle position detection unit 20 includes, for example, a global navigation satellite system (GNSS) receiver, an azimuth sensor, a distance sensor, and the like, and detects the position (longitude, latitude) of the user's vehicle at predetermined time intervals.

The user's own vehicle detection unit 30 detects behavior of the own vehicle that is traveling (specifically, sudden steering wheel operation by the driver and movement of the user's vehicle corresponding to this operation) on the basis of the detection result of the steering angle sensor 10 and the vehicle position detection unit 20.

The rear view camera 40 is provided at the rear of the vehicle, and images the rear view including the lane on which the user's vehicle is traveling.

The front view camera 42 is provided at the front of the vehicle, and images the front view including the lane on which the user's vehicle is traveling.

The rear view radar 44 is provided at the rear of the vehicle, and detects the position of the nearest following vehicle traveling on the lane on which the user's vehicle is traveling (the distance from the user's vehicle, the angle in the left-right direction, and the like).

The front view radar 46 is provided at the front of the vehicle, and detects the position of the nearest preceding vehicle traveling on the lane on which the user's vehicle is traveling (the distance from the user's vehicle, the angle in the left-right direction, and the like).

The neighboring vehicle detection unit 50 detects behavior of a neighboring vehicle preceding the user's vehicle, a neighboring vehicle following the user's vehicle, or both of neighboring vehicles that are traveling on the same lane as the user's vehicle (a preceding vehicle and/or a following vehicle). For example, the neighboring vehicle detection unit 50 detects behavior of the following vehicle by extracting features that can specify the position of the following vehicle such as headlights and a vehicle body contour of the following vehicle on the basis of the image obtained by the imaging by the rear view camera 40. Instead of or in addition to that, the neighboring vehicle detection unit 50 detects behavior of the preceding vehicle by extracting features that can specify the position of the preceding vehicle such as brake lamps and a vehicle body contour of the preceding vehicle on the basis of the image obtained by the imaging by the front view camera 42. Furthermore, the neighboring vehicle detection unit 50 detects the behavior of the following vehicle on the basis of the position of the following vehicle detected by the rear view radar 44. Instead of or in addition to that, the neighboring vehicle detection unit 50 detects the behavior of the preceding vehicle on the basis of the position of the preceding vehicle detected by the front view radar 46.

The road determination unit 60 determines a condition of the road on which the own vehicle is traveling on the basis of the behavior of the user's vehicle detected by the user's own vehicle detection unit 30 and the behavior of the neighboring vehicle detected by the neighboring vehicle detection unit 50. For example, the road determination unit 60 determines a condition of the road including the presence or absence of an obstacle on the road and the presence or absence of damage to the road that obstructs traveling. Specifically, the road determination unit 60 determines that there is an obstacle or a damaged spot on a case where the behavior of the user's vehicle is movement for avoiding the obstacle or the damaged spot on the road and the behavior of the neighboring vehicle is movement that is the same or similar movement.

The transmission information creation unit 70 creates transmission information (road information) including supplementary information indicating the presence of a dangerous spot such as an obstacle or a damaged spot obtained by the determination by the road determination unit 60 and position information of the user's vehicle. The transmission unit 72 transmits the road information created by the transmission information creation unit 70 to the road information processing server 2. This transmission may be performed, for example, via a telephone line using an external portable terminal device (not illustrated) or via an access point installed along the road.

The above-described user's own vehicle detection unit 30 corresponds to a user's own vehicle detection unit, the above-described neighboring vehicle detection unit 50 corresponds to a neighboring vehicle detection unit, the above-described road determination unit 60 corresponds to a road determination unit, and the above-described transmission information creation unit 70 and transmission unit 72 correspond to a road information transmission unit.

The in-vehicle device 1 (road information collection device) according to the present embodiment has the above-described configuration. Next, the operation thereof will be described.

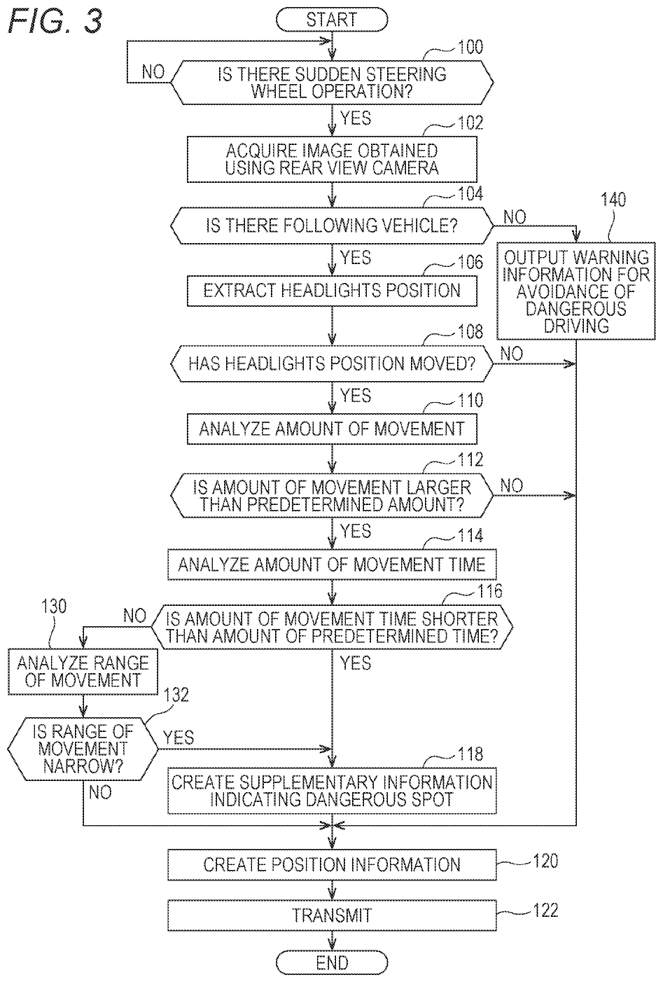

FIG. 3 is a flowchart illustrating an operation procedure for detecting a dangerous spot such as an obstacle during traveling and transmitting the information. FIG. 3 illustrates an operation procedure in a case where the user's own vehicle detects a dangerous spot by the rear view camera 40 imaging a following vehicle.

First, the user's own vehicle detection unit 30 determines whether sudden steering wheel operation is performed by the driver (step 100). This determination is made on the basis of the amount of change of the steering angle of the steering wheel detected at predetermined time intervals by the steering angle sensor 10, but may be made on the basis of the position of the user's vehicle detected by the vehicle position detection unit 20. In a case where sudden steering wheel operation is not performed, negative determination is made, and this determination is repeatedly performed.

On the other hand, in a case where sudden steering wheel operation is performed by the driver, positive determination is made in the determination in step 100. Next, the neighboring vehicle detection unit 50 acquires an image obtained by imaging the rear view of the user's vehicle using the rear view camera 40 (step 102), and determines whether there is a following vehicle traveling on the same lane as the own vehicle in this image (step 104). For example, contour shapes of a plurality of types of vehicle models are registered in advance and whether a partial image that matches (or is similar to) any of the contour shapes of the plurality of vehicle models is included in the acquired image is checked, whereby this determination can be made. In a case where there is a following vehicle, a positive determination is made in the determination in step 104.

Next, the neighboring vehicle detection unit 50 extracts the headlights position of the following vehicle from the acquired image (step 106), and determines whether the headlights position has moved (step 108). The headlights position can be extracted by a partial image having luminance that is a predetermined value or more being specified when the headlights are turned on, and can be extracted by a partial image corresponding to the headlights arranged to be separated to the left and right of the front surface of the vehicle being specified when the headlights are turned off. In a case where movement of the headlights position has been confirmed, positive determination is made in the determination of step 108.

Next, the road determination unit 60 analyzes the amount of the movement of the headlights position that has been confirmed to be moved (step 110), and determines whether the amount of the movement obtained by this analysis is larger than a predetermined amount (step 112). In a case where the amount of the movement is larger than the predetermined amount, a positive determination is made. Next, the road determination unit 60 analyzes the amount of time when the headlights position has been moved (amount of movement time) (step 114), and determines whether the amount of the movement time obtained by this analysis is shorter than the amount of a predetermined time (step 116). In a case where the amount of the movement time is shorter than the amount of the predetermined time (in a case where the following vehicle performs sudden steering wheel operation to avoid a dangerous spot similar to the user's vehicle), a positive determination is made.

Next, the transmission information creation unit 70 creates supplementary information indicating that there is a dangerous spot (step 118), and creates position information of the user's vehicle at the time when sudden steering wheel operation is performed in the own vehicle (step 120), and the transmission unit 72 transmits these pieces of information as road information to the road information processing server 2 (step 122).

On the other hand, in a case where the amount of the movement time is longer than the amount of the predetermined time, a negative determination is made in the determination in step 116. In this case, the road determination unit 60 analyzes the range of the movement (width of movement) (step 130), and determines whether the range of the movement is narrower than a predetermined width (step 132). In a case where the width of the movement is narrower than the predetermined width (in a case where the dangerous spot is relatively long along the road, and the amount of the movement time is relatively long but the width of the movement is narrow), a positive determination is made. In this case, the processing proceeds to step 118, and the supplementary information and position information are created, and the road information is transmitted (steps 118, 120, and 122).

Note that in a case where there is no following vehicle (a negative determination in the determination in step 104), the presence or absence of the dangerous spot cannot be determined, therefore, warning information for urging avoidance of dangerous driving in response to sudden steering wheel operation by the driver is output via display or voice (step 140). On the other hand, in a case where there is no movement of the headlights position (a negative determination in the determination of step 108), in a case where the amount of the movement of the headlights position is smaller than the predetermined amount (a negative determination in the determination of step 112), and in a case where the range of the movement of the headlights position is wider than the predetermined range (a negative determination in the determination in step 132, for example, in a case where the following vehicle changes lanes), the supplementary information indicating the dangerous spot is not created, and only the position information is created (step 120) and transmitted (step 122).

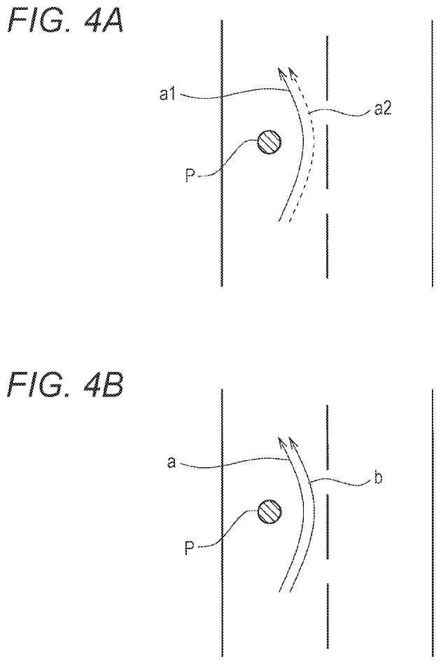

FIGS. 4A to 4B are diagrams illustrating an outline of dangerous spot detection. In the present embodiment, as illustrated in FIG. 4A, in a case where there is a dangerous spot P on a road (obstacle on a road, a cave-in in a road, a pedestrian rushing out into a road, a bicycle traveling on a road shoulder, and the like), the user's vehicle performs steering wheel operation so as to avoid the dangerous spot P and travels along a trajectory indicated by an arrow a1. Similarly, a neighboring vehicle traveling following the own vehicle also performs steering wheel operation so as to avoid the dangerous spot P and travels along a trajectory indicated by an arrow a2. The user's vehicle can determine the presence of the dangerous spot P by checking such behavior of the neighboring vehicle, and can transmit road information for notifying the presence of the dangerous spot P to the road information processing server 2. The road information processing server 2 can recognize the presence of the dangerous spot P on the basis of the road information transmitted from one vehicle.

On the other hand, conventionally, as illustrated in FIG. 4B, in a case where there is a dangerous spot P on a road and only one vehicle has passed by avoiding the dangerous spot P along a trajectory of an arrow a, whether the dangerous spot P actually exists or the driver has erroneously performed the steering wheel operation and traveled along the arrow a cannot be distinguished, and the presence of the dangerous spot P can be recognized only in a case where another vehicle travels along a similar trajectory (arrow b).

As described above, in the in-vehicle device 1 according to the present embodiment, not only the behavior of the user's own vehicle but also the behavior of a following neighboring vehicle are referred to, whereby whether the behavior of the user's vehicle is based on an erroneous steering wheel operation or is based on a road state can be distinguished, and a factor not related to the road state such as an erroneous steering wheel operation can be removed, and thus, the condition of a road can be accurately grasped. In particular, it is possible to reliably recognize that there is a dangerous spot on a road such as an obstacle that is large enough to be avoided during traveling or a damaged spot such as a large pothole.

Furthermore, behavior of a neighboring vehicle can be accurately detected by the behavior of the neighboring vehicle being detected on the basis of an image obtained by imaging by the rear view camera 40. In particular, since the headlights when turned on have high luminance, these portions can be easily extracted, and the behavior of the neighboring vehicle can be detected by simple processing.

Note that the present invention is not limited to the above-described embodiment. For example, in the above-described embodiment, behavior of a following vehicle is determined on the basis of an image obtained by imaging by the rear view camera 40, but the behavior of a following vehicle may be determined by the rear view radar 44. Instead of or in addition to the behavior of a following vehicle, behavior of a preceding vehicle may be determined using the front view camera 42 or the front view radar 46 to determine a dangerous spot. In this case, regardless of the presence or absence of sudden steering wheel operation in the user's own vehicle, the behavior of a preceding vehicle may be recorded for a predetermined time, and in a case where a sudden steering wheel operation is performed, the behavior of the preceding vehicle that has been recorded may be read to determine a dangerous spot.

In the above embodiment, the presence or absence of a dangerous spot is determined on the basis of the behavior of the user's own vehicle and behavior of a neighboring vehicle that is following or preceding the own vehicle, however, since the position of the neighboring vehicle moves left and right also in a case where the road is curved or in a case of turning right or left, there is a possibility that an erroneous determination may occur depending on the movement pattern. For this reason, for example, road data of a navigation device may include places or sections in which this erroneous determination may occur, and in a case where the position of the user's vehicle approaches these places or sections, this determination may be canceled even in a case where a determination that there is a dangerous spot is made.

### INDUSTRIAL APPLICABILITY

As described above, according to the present invention, not only the behavior of the user's own vehicle but also the behavior of neighboring vehicles that are preceding and following the user's vehicle are referred to, whereby whether the behavior of the user's vehicle is based on an erroneous steering wheel operation or is based on a road state can be distinguished, and a factor not related to the road state such as an erroneous steering wheel operation can be removed, and thus, the condition of a road can be accurately grasped.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A road information collection device that collects road information, the road information collection device comprising:
a user's own vehicle detection unit that detects behavior of a user's vehicle that is traveling;
a neighboring vehicle detection unit that detects behavior of a neighboring vehicle preceding the user's vehicle, a neighboring vehicle following the user's vehicle, or both of neighboring vehicles;
a road determination unit that determines a condition of a road on which the user's vehicle is traveling on a basis of behavior of the user's vehicle detected by the user's own vehicle detection unit and behavior of a neighboring vehicle detected by the neighboring vehicle detection unit; and
a road information transmission unit that transmits road information including a determination result by the road determination unit.

2. The road information collection device according to claim 1, wherein the road determination unit determines a condition of a road including presence or absence of an obstacle on the road.

3. The road information collection device according to claim 2, wherein the road determination unit determines that there is an obstacle in a case where behavior of the user's vehicle is a movement of avoiding an obstacle and behavior of a neighboring vehicle is same or similar movement of avoidance.

4. The road information collection device according to claim 3, wherein the road determination unit determines a condition of a road including presence or absence of damage to a road that obstructs traveling of a vehicle.

5. The road information collection device according to claim 4, wherein the road determination unit determines that there is a damaged spot on a road in a case where behavior of the user's vehicle is a movement of avoiding a damaged spot on a road and behavior of a neighboring vehicle is a movement that is same as or similar to this movement.

6. The road information collection device according to claim 5, further comprising
cameras that image the neighboring vehicle, wherein the neighboring vehicle detection unit detects behavior of a neighboring vehicle on a basis of an image obtained by the cameras.

7. The road information collection device according to claim 6, wherein the neighboring vehicle detection unit detects behavior of a neighboring vehicle on a basis of movement of turned-on lights of a neighboring vehicle included in an image obtained by the cameras.

8. The road information collection device according to claim 4, further comprising
cameras that image the neighboring vehicle, wherein the neighboring vehicle detection unit detects behavior of a neighboring vehicle on a basis of an image obtained by the cameras.

9. The road information collection device according to claim 8, wherein the neighboring vehicle detection unit detects behavior of a neighboring vehicle on a basis of movement of turned-on lights of a neighboring vehicle included in an image obtained by the cameras.

10. The road information collection device according to claim 2, wherein the road determination unit determines a condition of a road including presence or absence of damage to a road that obstructs traveling of a vehicle.

11. The road information collection device according to claim 10, wherein the road determination unit determines that there is a damaged spot on a road in a case where behavior of the user's vehicle is a movement of avoiding a damaged spot on a road and behavior of a neighboring vehicle is a movement that is same as or similar to this movement.

12. The road information collection device according to claim 11, further comprising
cameras that image the neighboring vehicle, wherein the neighboring vehicle detection unit detects behavior of a neighboring vehicle on a basis of an image obtained by the cameras.

13. The road information collection device according to claim 12, wherein the neighboring vehicle detection unit detects behavior of a neighboring vehicle on a basis of movement of turned-on lights of a neighboring vehicle included in an image obtained by the cameras.
